(19) United States
(12) Patent Application Publication
(10) Pub. No.: US 2026/0042433 A1
(43) Pub. Date: Feb. 12, 2026

(54) A TRAILER BRAKING SYSTEM

(71) Applicant: Haldex AB, Landskrona (SE)

(72) Inventor: Dudley Harrison, Lindley Warwickshire (GB)

(21) Appl. No.: 19/099,609

(22) PCT Filed: Jul. 28, 2023
(86) PCT No.: PCT/EP2023/071060

§ 371 Date: Jan. 29, 2025

(30) Foreign Application Priority Data
Jul. 29, 2022 (GB) 2211103.3

(51) Int. Cl. B60T 13/38; B60D 1/62; B60T 7/20; B60T 13/68; B60T 17/06

(52) U.S. Cl. CPC B60T 13/385; B60D 1/62; B60T 7/20; B60T 13/683; B60T 17/06; B60T 2270/402

(57) ABSTRACT

A trailer braking system includes a supply line, a spring brake that moves from an apply position to a release position, a spring brake control valve which controls the flow of fluid to the spring brake, an immobiliser having a brake release and immobilise positions which control the flow of fluid to the spring brake control valve, an auxiliary control valve having a system enabled configuration where the immobiliser is operable to move both to the brake release position in which the immobiliser permits fluid to the spring brake control valve and the spring brake control valve is operable to cause the flow of pressurised fluid into the spring brake, and an immobilise position where fluid is not permitted to the spring brake control valve, and in the system disabled configuration, the immobiliser is placed in the immobilise position.

### FIELD

The invention relates to a trailer braking system. In embodiments, the invention is used in a trailer that is connectable to a towing vehicle but it may also be used in semi-trailers and/or a dolly.

### BACKGROUND

Heavy goods vehicles made up of a towing vehicle and a trailer are well known. It is extremely important that when such a vehicle is stopped for any length of time the vehicle is braked adequately to ensure the vehicle is not in danger of rolling away. The consequences of inadequate stopping mechanisms can result in serious injury and/or death to persons working in and around a vehicle.

Embodiments of the present invention aim to alleviate one or more problems or drawbacks associated with known systems.

### BRIEF DESCRIPTION OF THE INVENTION

According to a first aspect of the invention we provide a trailer braking system including:
a supply line for connection to a continuous source of pressurised fluid;
a spring brake, which has an apply position and a release position, and where the spring brake moves to the release position when pressurised fluid is provided at or above a threshold;
a spring brake control valve, which controls the flow of fluid to the spring brake;
an immobiliser having a brake release position and an immobilise position, which control the flow of fluid to the spring brake control valve,
an auxiliary control valve, which is electrically operable, having a system enabled configuration and a system disabled configuration, wherein
in the system enabled configuration, the immobiliser is operable to move both to the brake release position, in which the immobiliser permits fluid to the spring brake control valve and the spring brake control valve is operable to cause the flow of pressurised fluid into the spring brake or to vent the spring brake, and to the immobilise position, in which fluid is not permitted to the spring brake control valve, and
in the system disabled configuration, the immobiliser is automatically placed in the immobilise position and fluid is not permitted to the spring brake control valve.

The auxiliary control valve may be positioned on the supply line and may be upstream of the immobiliser and spring brake control valve. The immobiliser may be positioned on the supply line and may be upstream of the spring brake control valve.

The immobiliser may have a control port which is a fluid pressure operated actuator, such that when the fluid pressure at the control port is at or above a threshold the immobiliser moves to its brake release position.

The braking system may include a trailer reservoir. The trailer reservoir may be connected to the supply line. The trailer reservoir may automatically fill when the trailer is fluidly connected to a towing vehicle such that an auxiliary supply of fluid is available for use in the trailer.

The trailer braking system may include an override valve. The override valve may have an activated position in which it connects the trailer reservoir to the immobiliser and/or connects the trailer reservoir to the spring brake control valve. The override valve may be electrically operable.

The auxiliary control valve may be a three-port valve. Optionally, a first port may connect to the supply line, a second port may connect to the immobiliser and a third port may provide a vent. The first port and the second ports of the auxiliary control valve may be connected in the system enabled configuration. The second port may be connected to the vent of the auxiliary control valve in the system disabled configuration. Optionally, a control signal to change the state of the auxiliary control valve may be provided by an electronic control unit (ECU).

The ECU may be operable to receive a control signal from an associated vehicle and/or another control source. The ECU may be (subsequently) operable to issue a signal to the auxiliary control valve.

The immobiliser may include a first port connected to the supply line and auxiliary control valve, a second port connected to the spring brake control valve, and a third port providing a vent to atmosphere. The first and second ports of the immobiliser may be connected and the third port is closed in the brake release position. The second port may be connected to the third port and a check valve may be connected between the first and second ports which permits fluid flow towards the first port only in the immobilise position.

The spring brake control valve may include a first port connected to the supply line, a second port connected to the spring brake, a third port providing a vent and a fluidly actuated control port connected to the supply line, immobiliser and auxiliary control valve.

The immobiliser may move to the immobilise position when the pressure in the supply line drops below a predetermined threshold automatically. The auxiliary control valve may move to its system disabled configuration and cause the supply line to vent automatically. Once the immobiliser is in the immobilise position, it may be moved to its brake release position only when the override valve connects the trailer reservoir to the control port of the immobiliser. The immobiliser may be operable to maintain the brake release position if there is pressure in the supply line and the auxiliary control valve is in its system enabled configuration.

The auxiliary control valve may be biased to the system enabled configuration. The immobiliser may be biased to the immobilise position. The override valve may be biased to the deactivated position in which the supply line is connected to the outlet, which is connected to the spring brake control valve. The spring brake control valve may be biased to the position in which fluid is vented from the spring brake.

According to a second aspect of the invention, we provide a method of controlling a trailer braking system including:
an immobilisation process including:
an electronic control unit (ECU) sending a signal to an auxiliary control valve and causing the auxiliary control valve to depressurise a supply line of pressurised fluid, and
causing a change in a position of an immobiliser to an immobilise position in which the supply line downstream of the immobiliser is depressurised,
causing a spring brake control valve to vent, and as such a spring brake is moved to an applied position in which an associated wheel is inhibited from rotating;
a mobilisation process including:
the ECU sending a sending a signal to an override valve and causing the override valve to connect a trailer reservoir to the immobiliser,
allowing fluid in the supply line to reach the spring brake control valve and maintaining the immobiliser in its brake release position; and the spring brake are released and the associated wheel is able to rotate.

The method may include the ECU receiving a signal from an associated vehicle concerning the auxiliary control valve which triggers sending the signal to the auxiliary control valve.

### BRIEF DESCRIPTION OF THE FIGURES

In order that the present disclosure may be more readily understood, preferable embodiments thereof will now be described, by way of example only, with reference to the accompanying drawings, in which:

FIG. 1 is a schematic view of part of a trailer braking system.

### DETAILED DESCRIPTION OF THE DISCLOSURE

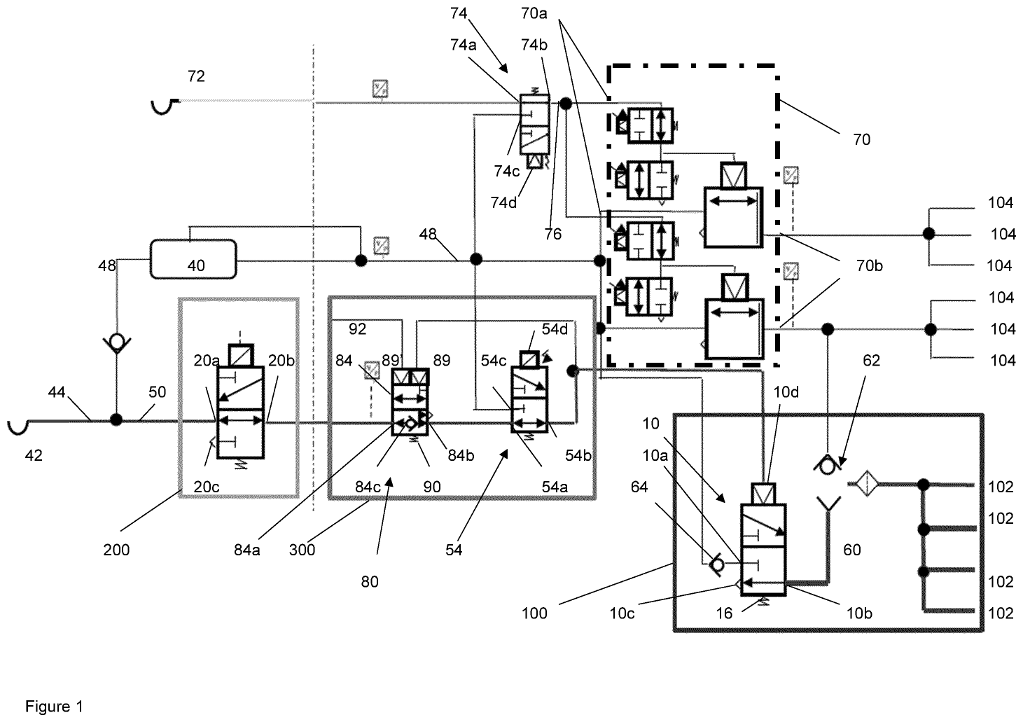

A braking system for a trailer vehicle is illustrated in FIG. 1 (individual wheel/wheel ends are not illustrated). The system is configured to control a brake actuator that has a spring brake chamber and a service brake chamber (both chambers are capable of imparting braking force on a connected wheel). The spring brake (the braking force controlled by the spring brake chamber) is applied when the fluid pressure (in this case, air) drops below a threshold and is released when the air pressure is at or above the threshold. In other words, the spring brake is on when there is low or no pressure in the chamber and the spring brake is released (applying no braking force) when there is pressure present in the chamber. The spring brake includes a resilient biasing element by means of which the braking force is applied when the pressure in the spring brake chamber is below the predetermined level.

In the illustrated example, the spring brake(s) are controlled by the fluid pressure exiting a spring brake control assembly 100. The fluid exiting the spring brake control assembly 100 does so through one or more outlets 102 (in the illustrated case, four outlets 102) and proceeds to the spring brake chamber.

The service brake (the braking force controlled by the service brake chamber) is applied according to the pressure present in the chamber and is released when the air pressure is below a threshold. In other words, the service braking force developed is proportional to the pressure present in the chamber.

There are one or more service outlets 104 (in the illustrated case, six service outlets 104) provided that are connected to the service brake chamber(s). It should be appreciated that one service outlet 104 may be provided for each wheel which has a service brake chamber or another arrangement may be used as desired.

The fluid that supplies the system is provided by a supply line 44 which connects to a source of continuous air (e.g. a towing vehicle that has a generator or fluid source). The supply line 44 splits to two continuously pressurised lines—a park line 50 and an emergency apply line 48. A trailer reservoir 40 is provided on the emergency apply line 48. The trailer reservoir 40 automatically fills when the trailer is fluidly connected to a towing vehicle such that an auxiliary supply of fluid is available for use in the trailer.

The service brake is activated/released in accordance with driver (or electronic braking system (EBS)) demand. A control line 72 is connectable to the tractor and provides a fluid line to the driver's brake pedal. When the control line 72 is pressured (i.e. the driver has pressure applied to the brake pedal), a control valve assembly 70 (includes at least a modulator) operates to impart the desired pressure to the service brake chamber (and, thus, the desired braking force is developed). The modulator has three configurations—a build state, a hold state and an exhaust state.

The build state is configured to increase the pressure delivered to the service brake chamber. The hold state is configured to maintain a consistent pressure delivered. And, the exhaust state is configured to vent the pressure developed to atmosphere (and the delivered pressure to the chamber drops to zero).

The modulator has a control port 70a for receipt of a fluid pressure braking demand signal (connected to the control line 72), a supply port which is connected to a source of pressurised fluid, a delivery port 70b which is connected to the service brake chamber, and an exhaust port which vents to a low pressure region/atmosphere.

In the build state, the supply port is connected to the delivery port 70b whilst the exhaust port is closed (i.e. the pressure increases due to the connection to the supply port). In the hold state, the exhaust port and the supply ports are closed (i.e. the pressure is held stable with no additional pressure coming from the supply port). In the exhaust state, the delivery port 70b is connected to the exhaust port whilst the supply port is closed (i.e. the pressure will drop as all the air is vented).

Either the EBS or the driver (via the control line 72) can provide the control pressure at the control port 70a of the control valve assembly 70 (along a service brake line 76). A brake apply valve 74 operates to connect either the control line 72 to the control valve assembly 70 or connects a constant supply of pressure from the trailer reservoir 40 to the control valve assembly 70. In this embodiment, the brake apply valve 74 is an electrically operated solenoid valve) and, in this example, is biased to connect the control line 72 to the control valve assembly 70). The brake apply valve 74 includes a first inlet 74a, an outlet 74b, a second inlet 74c and a control solenoid 74d. The control line 72 is connected to the first inlet 74a and the second inlet 74c is connected to the trailer reservoir 40 via a trailer reservoir supply line. The outlet 74b is connected to the control valve assembly 70.

The brake apply valve 74 is movable between a first position in which the first inlet 74a is connected to the outlet 74b, whilst the second inlet 74c is closed, and a second position in which the first inlet 74a is closed and the second inlet 74c is connected to the outlet 74b. The brake apply valve 74 is electrically operable, in this example, by means of a solenoid. Mechanical biasing means (in this example a spring) is provided to urge the brake apply valve 74 into the first position. Movement of the brake apply valve 74 from the first position to the second position is achieved by the supply of an electrical current to the solenoid 74d.

Thus, the driver demand pressure along the control line 72 is the default pressure delivered to the control valve assembly 70. However, the EBS can control the signal at port 74d in order to connect the trailer reservoir 40 the control valve assembly 70. This results in the EBS being operable to control the pressure going to the control valve assembly 70—this is necessary so that the trailer can provide stability control automatically and independently of the driver demand for braking, for example.

The outlet 70b (or one of the outlets 70b) of the modulator(s) 70 and an outlet from a spring brake control valve 10 (SBCV 10) are also connected to an anti-compounding valve 62. This is a two-way check valve which acts to connect whichever of the outlet of the SBCV 10 (discussed below) or the outlet 70b of the modulator 70 is carrying the highest pressure to the spring brake chamber. Such anti-compounding valves prevent the brakes being damaged by the simultaneous application of a braking force from the spring brake and service brake.

In embodiments, the spring brake control assembly 100 includes the SBCV 10. The spring brake control assembly 100 may also include the anti-compounding valve 62 and/or the spring outlets 102 and/or an additional check valve 64.

The SBCV 10 operates to control the air pressure permitted to the spring brake chamber. The SBCV 10 has an inlet 10a, an outlet 10b, an exhaust port 10c and a control port 10d. The inlet 10a connects to a source of pressurised fluid, the outlet 10b connects to the spring brake chamber (via a spring brake line 60), and the exhaust port 10c is connected to a low pressure region (e.g. atmosphere).

The spring brake control valve 10 is movable between a first position where the inlet 10a is connected to the outlet 10b whilst the exhaust port 10c is closed, and a second position in which the outlet 10b is connected to the exhaust port 10c whilst the inlet 10a is closed.

The control port 10d is a fluid pressure operated actuator. The fluid pressure operated actuator being configured such that the supply of pressurised fluid to the control port 10d causes the spring brake control valve 10 to move to its first position. The spring brake control valve 10 also has a resilient biasing element 16 (e.g. a spring) which acts to urge the spring brake control valve 10 into its second position. When the fluid pressure at the control port 10d exceeds a pre-determined level/threshold, the spring brake control valve 10 moves positions, against the biasing force of the resilient biasing element 10, from the second position to the first position.

The inlet 10a is connected to the supply line 44 (in this example, via the emergency apply line 48, and trailer reservoir 40). The control port 10d of the spring brake control valve 10 is connected to the supply line 44 (in this example, via the park line 50 and through an auxiliary control valve 200 and a park control subsystem 300).

In some embodiments, the park control subsystem 300 includes an immobiliser 80 and an override valve 54.

The immobiliser 80 is configured to interrupt operation of the spring brake. The immobiliser 80 operates to move to an immobilise position automatically when pressure in the supply line 44, 50 is lost or is decreased below a predetermined threshold (which forces the spring brake control valve 10 to vent due to being downstream of the immobiliser 80). Thus, the spring brake moves to a brake applied position and the immobiliser 80 also moves to the “immobilised” state when the pressure is lost or below that threshold in the supply line 44/park line 50.

In more detail, the immobiliser 80 includes an immobiliser valve 84. The immobiliser valve 84 has an inlet 84a, an outlet 84b and a control port 89. A resilient biasing element 90 (e.g. a spring) is provided to urge the immobiliser valve 84 to a default position when the control port 89 is not in use. The inlet 84a is connected to the supply line 44 via the park line 50 (and the auxiliary control valve 200). The outlet 84b is connected to the control port 10d of the SBCV 10 via the override valve 54. The control port 89 is a fluid pressure operated actuator. The outlet 84b is also connected to the control port 89 via the override valve 54.

The immobiliser 80 has two states—a brake apply/active immobilisation state and a brake release/inactive state. These states/positions which positions control the flow of pressurised fluid to the spring brake control valve 10. The state illustrated in FIG. 1 is the brake apply position in which fluid is prevented from travelling downstream of the immobiliser 80 (i.e. towards the SBCV 10). The inlet 84a is connected to the outlet 84b via a check valve 84c—and thus, the supply line 44/park line 50 pressure is not permitted to flow to the control port 10d of the SBCV 10. The illustrated position is achieved automatically when the supply line 44 is connected to a low pressure region (i.e. this could be on disconnection of a towing vehicle from the trailer). The immobiliser 80 automatically moves to its immobilise position in which the spring brake control valve 10 is not operable.

In the immobilise position, pressure on the supply line 44 is prevented from reaching the control port 10d of the SBCV 10 (and, thus, the spring brake cannot function to allow pressure through to the spring brake chamber 58a because the SBCV 10 is biased to vent by default). Furthermore, the biasing element 90 urges the immobiliser 80 to its immobilisation state, so once there is no fluid on the outlet 84b side of the valve, the immobiliser 80 cannot be repressurised merely by connecting the supply line 44 to a source of fluid.

In its brake release/inactive state, the immobiliser 80 permits fluid to flow towards the SBCV 10 and the spring brake can be operated as normal. In other words, the inlet 84a connects to the outlet 84b and thus, the fluid on the park line 50 coming from the supply line 44 is permitted to flow to the control port 10d of the SBCV 10. The immobiliser 80 maintains this state as long as there is sufficient pressure at one of the control ports 89, 89′. It should be appreciated that once the continuous flow of fluid on the supply line 44/park line 50 is permitted through the immobiliser 80, the outlet 84b is connected to the control port 89, so the continuous pressure holds the immobiliser 80 in the brake release position.

In embodiments, the immobiliser valve 84 may be provided with two fluid pressure operated actuators 89, 89′. As mentioned above, the first fluid pressure operated actuator 89 is connected to the outlet 84b of the immobiliser valve 84 and, thus, to the control port 10d of the spring brake control valve 10. In other words, it pushes the immobiliser valve 84 against the biasing force of the spring 90 into its brake release position when pressure is present at the control port 10d of the SBCV 10/outlet 54b of the override valve 54.

The second fluid pressure operated actuator 89′is connected to an alternative source of pressurised fluid via a port 92. The second fluid pressure operated actuator 89′is configured to move the immobiliser valve 84 against the biasing force of the spring 90 into its brake release position when the pressure of fluid from the alternative source of pressurised fluid exceeds a pre-determined threshold.

It should also be appreciated that the immobiliser valve 84 may include an exhaust port attached to the check-valve 84c provided between the inlet 84a and the outlet 84b. Thus, when the immobiliser 80 moves to the active immobilisation state, the pressure on the outlet 84b side of the immobiliser valve 84 may automatically vent (and not be able to repressurise until the immobiliser 80 is operated to change states again).

The override valve 54 also has a first and second inlet 54a, 54c, and an outlet 54b. The first inlet 54a is connected to the outlet of the immobiliser 80 (i.e. connected on the park line 50). The second inlet 54c is connected to the emergency apply line 48 (and, therefore, to the trailer reservoir 40). The outlet 54b is connected to the control port 10d of the spring brake control valve 10 and the control port 89 of the immobiliser 80.

The override valve 54 has a first position in which the inlet 54a is connected to the second port 54b, and the third port 54c is closed, and a second position in which the second inlet 54c is connected to the outlet 54b whilst the first inlet 54a is closed. In other words, in the first position, the park line 50 (and thus, the supply line 44) is connected to the control of the immobiliser 80 and the control of the SBCV 10. In the second position (an activated position), the trailer reservoir 40 is connected to the control of the immobiliser 80 and the control of the SBCV 10.

The override valve 54 is electrically operable, in this example, by means of a solenoid 54d. Mechanical biasing means (in this example a spring) is provided to urge the override valve 54 into the first position. In other words, the override valve 54 is biased to its first position (a deactivated position) when there is no signal provided at the solenoid 54d. Movement of the override valve 54 from the first position to the second position is achieved by the supply of an electrical current to the solenoid 54d.

The supply of electrical power to the override valve 54 and the brake apply valve 74 is provided by a control unit (e.g. the trailer EBS control unit/an electronic control unit (ECU)).

The auxiliary control valve 200 has a system enabled configuration and a system disabled configuration (the system enabled configuration is illustrated in FIG. 1). When the auxiliary control valve 200 is in the system enabled configuration, the immobiliser is operable to move both to the brake release position and to the immobilise position (i.e. it may operate normally as described above).

When the auxiliary control valve 200 is in the system disabled configuration, the immobiliser 80 is automatically placed in the immobilise position and fluid is not permitted to the SBCV 10.

In some embodiments, the auxiliary control valve 200 has three ports. The first port 20a connects to the supply line 44/park line 50, the second port 20b connects to the immobiliser 80 and the third port 20c provides a vent (e.g. to atmosphere). The first port 20a and the second port 20b are connected in the system enabled configuration. The second port 20b is connected to the vent 20c in the system disabled configuration.

In some embodiments (see illustrated system in FIG. 1), the auxiliary control valve 200 is electrically operable. The ECU/EBS control unit is operable to send a control signal to change the state of the auxiliary control valve 200.

It should be appreciated that that the auxiliary control valve 200 may be controllable pneumatically (in which case a pneumatic connection to a reservoir is provided). The important functionality is that the ECU is operable to control the configuration of the auxiliary control valve 200.

In embodiments, the auxiliary control valve 200 is positioned on the supply line 44 and upstream of the immobiliser 80. As such, the auxiliary control valve 200 is also upstream of the SBCV 10.

The manner in which the system operates will now be discussed.

Under normal driving conditions, a connector 42 is pressurised by virtue of its connection to “the red line”, i.e. the tractor based supply of pressurised fluid. This provides fluid into the supply line 44.

The immobiliser 80 is in its brake release position. As a result, the control port 10d is connected to the supply line 44 and is therefore pressurised, and, the spring brake control valve 10 is also in its first position. Pressurised fluid can therefore flow from the supply line 44 (and the trailer reservoir 40), along the emergency apply line 48 and through the SBCV 10 to the spring brake chamber to release the spring brakes.

When the trailer is left without a towing vehicle, the connector 42 is disconnected from the external source of pressurised fluid and the supply line 44 thus exhausted to atmosphere. In the absence of pressurised fluid at the control port 10d of the spring brake control valve 10, the spring brake control valve 10 moves to its second (default/unpressurised) position. As a result, the inlet 10a is closed, and the outlet 10b is connected to the exhaust port 10c. The spring brake chamber 58a is thus vented to atmosphere via the exhaust port 10c, and the spring brake applied.

Further, when the connector 42 is disconnected from the supply of fluid from the towing vehicle, pressure is also lost at the control port 89 of the immobiliser valve 84 and the immobiliser 80 automatically moves to its active/immobilisation state. Thus, the trailer is automatically immobilised with the spring brakes applied. In other words, the immobiliser 80 moves to the immobilise position when the pressure in the supply line 44 drops below a predetermined threshold automatically.

However, there may be instances when the vehicle (towing part and trailer) are stopped and parked up but the supply line 44 is not disconnected from the towing vehicle. In such a situation, the immobiliser 80 will not automatically switch to its immobilise state because the supply line 44 is not below a pressure threshold. Previous systems often relied on the service brakes to hold the vehicle in position. However, the present system provides an alternative that allows the spring brakes to apply even without disconnection of the supply line 44.

An “immobilisation process” involves the electronic control unit (ECU) sending a signal to the auxiliary control valve 200 and causing the auxiliary control valve 200 to depressurise the supply line 44 downstream of the valve 200 (i.e. the park line 50 towards the immobiliser 80 and SBCV 10 is depressurised). This causes the immobiliser 80 to move to an immobilise position in which the supply line 44 is inhibited/prevented from reaching the spring brake control valve 10. Thus, the spring brake control valve 10 moves to the default (vent) state, and as such the spring brake moves to an applied position in which associated wheels are inhibited from rotating.

In other words, the ECU signals to the auxiliary control valve 200 for it to move to its system disabled configuration. This step causes the downstream supply line 44 to vent and resulting drop in supply line 44 pressure causes the immobiliser 80 to move to its immobilise position. The supply line 44 downstream of the immobiliser 80 is unable to repressurise and the spring brake is also vented via the SBCV 10. Essentially, the vehicle is immobilised without having to disconnect the towing vehicle—the supply line 44 remains pressurised upstream of the immobiliser 80.

In some embodiments, the auxiliary control valve 200 is biased to its system enabled configuration, so after the signal is received from the ECU (and the auxiliary control valve 200 switches to the system disabled configuration), it will return to the system enabled configuration. In other words, the auxiliary control valve 200 is pulsed to its system disabled configuration when it receives a corresponding pulse signal from the ECU (the pulse will be long enough to ensure the immobiliser 80 switches to its immobilise position).

Once the immobiliser 80 is in the immobilise position it is biased to maintain that state.

A “mobilisation process” includes the ECU sending a sending a signal to the override valve 54 and causing the override valve 54 to connect the trailer reservoir 40 to the immobiliser 80 (and, as such, fluid arrives at the spring brake control valve 10). Further, the supply of fluid to the control of the immobiliser 80 holds the immobiliser 80 in the brake release position and, as such, continuous pressure reaches the SBCV 10 and the spring brakes are released (and the associated wheels can rotate).

In other words, the immobiliser 80 will only be moved to its brake release position when the override valve 54 connects the trailer reservoir 40 to the control port 89 of the immobiliser 80. The immobiliser 80 operates to maintain the brake release position if there is pressure in the supply line 44 and the auxiliary control valve 200 is in its system enabled configuration.

In some embodiments, the immobilisation process is triggered by the ECU receiving a signal from an associated vehicle. The towing vehicle may have a button or switch in the driver's cab that allows manual operation and as such the driver may initiate the immobilisation process. It should be appreciated that in the case of an autonomous towing vehicle or other vehicle that is engaged to move the trailer, the associated vehicle may still be able to issue a signal to the ECU to trigger the immobilisation process but this signal will not be driver actuated (as there may be no human driver or operator).

Further, the mobilisation process may be triggered by another switch or button in the cab that the driver can manually operate or it may be triggered by another process such as a brake pedal depression (or some combination of the two—i.e. a button press but the ECU waits to mobilise until the foot brake is pressed). Alternatively, in the case of an autonomous towing vehicle, the signal could be sent automatically once the towing vehicle is ready to depart/move.

This process is advantageous because it allows the vehicle to be placed in an unmovable state (because of the immobiliser 80) even while the towing vehicle is still connected to the trailer. Thus, commands can be issued from an operator and/or system in a remote location or by the towing vehicle alone (under an autonomous routine)—essentially, no operation actuators or processes are required to be managed or initiated by a human operator. This system maintains safety and ensures the trailer cannot be moved when it is immobilised and improves the flexibility of operation (i.e. allowing for an operator or driver not to be present at all or at least sometimes).

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1.-24. (canceled)

25. A trailer braking system including:
a supply line for connection to a continuous source of pressurised fluid;
a spring brake having an apply position and a release position, where the spring brake moves to the release position when pressurised fluid is provided at or above a threshold;
a spring brake control valve which controls the flow of fluid to the spring brake;
an immobiliser having a brake release position and an immobilise position which control the flow of fluid to the spring brake control valve; and
an auxiliary control valve which is electrically operable and has a system enabled configuration and a system disabled configuration, wherein:
in the system enabled configuration, the immobiliser is operable to move both to the brake release position, in which the immobiliser permits fluid to the spring brake control valve and the spring brake control valve is operable to cause the flow of pressurised fluid into the spring brake or to vent the spring brake, and to the immobilise position, in which fluid is not permitted to the spring brake control valve; and
in the system disabled configuration, the immobiliser is automatically placed in the immobilise position and fluid is not permitted to the spring brake control valve.

26. The trailer braking system according to claim 25, wherein the auxiliary control valve is positioned on the supply line and upstream of the immobiliser and spring brake control valve.

27. The trailer braking system according to claim 25, wherein the immobiliser is positioned on the supply line upstream of the spring brake control valve.

28. The trailer braking system according to claim 25, wherein the immobiliser has a control port which is a fluid pressure operated actuator, such that when the fluid pressure at the control port is at or above a threshold the immobiliser moves to the brake release position.

29. The trailer braking system according to claim 25, further comprising:
a trailer reservoir which is connected to the supply line and automatically fills when the trailer is fluidly connected to a towing vehicle such that an auxiliary supply of fluid is available for use in the trailer.

30. The trailer braking system according to claim 29, further comprising:
an override valve which has an activated position in which the override valve connects the trailer reservoir to the immobiliser and/or connects the trailer reservoir to the spring brake control valve.

31. The trailer braking system according to claim 30, wherein the override valve is electrically operable.

32. The trailer braking system according to claim 25, wherein the auxiliary control valve comprises a three-port valve and a first port connects to the supply line, a second port connects to the immobiliser and a third port provides a vent.

33. The trailer braking system according to claim 32, wherein the first port and the second ports of the auxiliary control valve are connected in the system enabled configuration and wherein the second port is connected to the vent of the auxiliary control valve in the system disabled configuration.

34. The trailer braking system according to claim 25, wherein a control signal to change the state of the auxiliary control valve is provided by an electronic control unit.

35. The trailer braking system according to claim 34, wherein the ECU is operable to receive a control signal from an associated vehicle and/or another control source and subsequently operable to issue a signal to the auxiliary control valve.

36. The trailer braking system according to claim 25, wherein the immobiliser includes a first port connected to the supply line and auxiliary control valve, a second port connected to the spring brake control valve, and a third port providing a vent to atmosphere.

37. The trailer braking system according to claim 36, wherein the first and second ports of the immobiliser are connected and the third port is closed in the brake release position, and the second port is connected to the third port and a check valve is connected between the first and second ports which permits fluid flow towards the first port only in the immobilise position.

38. The trailer braking system according to claim 25, wherein the spring brake control valve includes a first port connected to the supply line, a second port connected to the spring brake, a third port providing a vent and a fluidly actuated control port connected to the supply line, immobiliser and auxiliary control valve.

39. The trailer braking system according to claim 25, wherein the immobiliser moves to the immobilise position when the pressure in the supply line drops below a predetermined threshold automatically.

40. The trailer braking system according to claim 39, wherein when the auxiliary control valve moves to its system disabled configuration, the supply line is vented automatically.

41. The trailer braking system according to claim 39, wherein the immobiliser has a control port which includes a fluid pressure operated actuator, such that when the fluid pressure at the control port is at or above a threshold the immobiliser moves to the brake release position; and further comprising:
a trailer reservoir which is connected to the supply line and automatically fills when the trailer is fluidly connected to a towing vehicle such that an auxiliary supply of fluid is available for use in the trailer; and
an override valve, which has an activated position in which the override valve connects the trailer reservoir to the immobiliser and/or connects the trailer reservoir to the spring brake control valve;
wherein once the immobiliser is in the immobilise position is moved to the brake release position only when the override valve connects the trailer reservoir to the control port of the immobiliser.

42. The trailer braking system according to claim 25, wherein the immobiliser is operable to maintain the brake release position if there is pressure in the supply line and the auxiliary control valve is in the system enabled configuration;
and/or wherein the auxiliary control valve is biased to the system enabled configuration;
and/or wherein the immobiliser is biased to the immobilise position.

43. The trailer braking system according to claim 25, wherein the override valve is biased to the deactivated position in which the supply line is connected to the outlet, which is connected to the spring brake control valve;
and/or wherein the spring brake control valve is biased to the position in which fluid is vented from the spring brake.

44. A method of controlling a trailer braking system comprising:
an immobilisation process comprising:
an electronic control unit (ECU) sending a signal to an auxiliary control valve and causing the auxiliary control valve to depressurise a supply line of pressurised fluid;
causing a change in a position of an immobiliser to an immobilise position in which the supply line downstream of the immobiliser is depressurized; and
causing a spring brake control valve to vent, and as such a spring brake is moved to an applied position in which an associated wheel is inhibited from rotating; and
a mobilisation process comprising:
the ECU sending a sending a signal to an override valve and causing the override valve to connect a trailer reservoir to the immobilise; and
allowing fluid in the supply line to reach the spring brake control valve and maintaining the immobiliser in its brake release position; and the spring brake are released and the associated wheel is able to rotate.

45. The method according to claim wherein the ECU receives a signal from an associated vehicle concerning the auxiliary control valve which triggers sending the signal to the auxiliary control valve.
